(19) United States
(12) Patent Application Publication
(10) Pub. No.: US 2023/0293275 A1
(43) Pub. Date: Sep. 21, 2023

(54) METHOD FOR DEFINING DIFFERENT LAYER ELEMENTS OF AN ARTIFICIAL TOOTH ELEMENT

(71) Applicant: VITA ZAHNFABRIK H. RAUTER GMBH & CO. KG, Bad Säckingen (DE)

(72) Inventor: Armin Kirsten, Bad Säckingen (DE)

(73) Assignee: VITA ZAHNFABRIK H. RAUTER GMBH & CO. KG, Bad Säckingen (DE)

(21) Appl. No.: 18/011,255

(22) PCT Filed: Jul. 7, 2021
(86) PCT No.: PCT/EP2021/068795

§ 371 Date: Dec. 19, 2022

(30) Foreign Application Priority Data
Jul. 20, 2020 (EP) 20186640.7

(51) Int. Cl. A61C 13/08; G06F 30/20

(52) U.S. Cl. CPC A61C 13/082; G06F 30/20

(57) ABSTRACT

A method for defining different layer elements of an artificial tooth element, having the following steps: defining an interface between an inner core element and an outer layer element at least partially surrounding the inner core element; selecting an additional layer element from a provided selection list containing a plurality of additional layer elements; and automatically arranging the at least one selected additional layer element in spatially defined relation to the core element and/or the outer layer element.

### BACKGROUND

### 1. Field of the Disclosure

The disclosure relates to a method for defining different layer elements of an artificial tooth element.

### 2. Discussion of the Background Art

When manufacturing artificial tooth elements, it is an essential objective that the artificial tooth element is as similar as possible in appearance to the natural teeth of the patient. In a natural tooth, the dentin is surrounded by the enamel in the visible portion. In particular, it is difficult to imitate the appearance of old teeth, since these often show additional effects.

For manufacturing tooth elements, which may be a complete artificial tooth, a crown or the like, it is known to likewise manufacture the tooth element from at least two different materials and to reproduce the interface between dentin and enamel. For this purpose, it is known from DE 10 2010 002 484 A1 to determine the interface between dentin and enamel of the natural patient tooth using an X-ray method, and to subsequently manufacture a tooth element in which an inner material imitating the dentin has the same geometrical shape as the natural dentin of the patient and, in particular, to form the material replacing the enamel with a layer thickness corresponding to the natural enamel. Since the materials that replace the enamel and the dentin in the artificial tooth element do not have the same optical characteristics as the natural materials, the optical appearance of artificial tooth elements manufactured in such a manner still differs from the optical appearance of the patient's other teeth.

It is an object of the disclosure to provide a method for defining different layers of an artificial tooth element, in order to provide an artificial tooth element, the optical characteristics of which correspond or are as close as possible to the optical characteristics of the patient's natural tooth.

### SUMMARY

According to the method of the disclosure, first an interface is defined between an inner core element and at least one outer layer element which surrounds the inner core element at least in part. Here, compared to the natural tooth, the inner core element corresponds to the portion in which the tooth comprises dentin. Compared to the natural tooth, the outer layer element corresponds in particular to the portion which comprises enamel.

The interface may be defined by imaging the actual interface between the enamel and the dentin of the natural tooth to be replicated.

Preferably, a definition of at least one interface is made inside ab artificial tooth element, wherein this does not necessarily have to correspond to the natural interface. The at least one interface represents an interface between at least two different materials from which the artificial tooth element is made. This interface does not or at least not completely correspond to the interface between the dentin and the enamel of the patient's natural tooth or is not defined in consideration of the actual interface. By defining at least one other interface, i.e., an interface differing at least in part from the natural interface, the optical characteristics of the materials used are used such that the optical appearance of an artificial tooth element thus manufactured is as close as possible to the optical appearance of the natural tooth and preferably essentially corresponds thereto.

First, the three-dimensional outer contour of the tooth element may be determined. Here, the outer contour of the artificial tooth element corresponds to the outer contour of the natural tooth to be replaced. This can be done, for example, by selecting a suitable outer contour from a tooth library, which is adapted to the individual anatomy, so as to meet the functional and aesthetic requirements of the restoration to be manufactured. As an alternative to the selection of the shape from a tooth library, it is also possible, e.g., in case of a single crown, to mirror the tooth contour of the opposite tooth. In a step which is performed in particular prior to the method of the present disclosure, a three-dimensional outer contour of a tooth element may be determined and in particular detected. It is also possible to open a data set which includes the three-dimensional outer contour of the tooth element.

Further, for preparing the method of the disclosure, a three-dimensional outer contour of the tooth element may be aligned to a coordinate system. The coordinate system is preferably related to anatomically defined direction designations, so that the coordinate system comprises in particular the directions mesial, distal, apical and incisal/occlusal. Aligning a tooth element to a coordinate system has the advantage that it is possible in a simple manner to define at least one interface located inside the tooth element, based on the three-dimensional outer contour of the tooth element.

A first boundary curve is defined on the tooth surface. A first boundary curve may be defined based on the tooth equator. The tooth equator is the largest circumference of a tooth in the region of the tooth crown. The first boundary curve may likewise be based on a preparation boundary as the curve, wherein the preparation boundary is the boundary between the artificially treated tooth element and the untreated tooth surface. It is also possible to define the first boundary curve manually at least in part. Further, it is possible to manually adjust a curve which has been defined in particular automatically for example based on the tooth equator and/or the preparation boundary. It is preferred that the first boundary curve is defined between the tooth equator and the preparation limit. Here, it is possible, for example, to define the first boundary curve at a fixed distance to the tooth equator and/or to the preparation boundary. In particular, the first boundary curve may have the same distance to the tooth equator and to the preparation boundary, i.e. be provided exactly between the tooth equator and the preparation boundary.

An incisal or occlusal tooth surface is determined with reference to the first boundary limit. According to the disclosure, this tooth surface is displaced inward. The displacement is in the direction of the surface normal, wherein the displacement is made in particular by different amounts. Thus, surface regions of the tooth surface exist that are displayed inward to a higher or a lesser degree. These different amounts of displacement are based on variable design parameters. The at least one interface is created by such displacement of the tooth surface.

The design parameter may vary in particular for different teeth of the patient. Different design parameters may be necessary, for example, if the restoration is performed on differently colored tooth stumps or the restorations are designed with different thicknesses, since the optical appearance of the tooth stumps influences the appearance of the artificial tooth element, due to the translucence of the materials used for the artificial tooth element. The design parameters are in particular also dependent on the material used. For example, a minimum wall thickness of a material may be predefined. This is the case in particular for the inner, in particular dentin-colored material that primarily determines the stability. Besides, the optical characteristics of polymer-based material differ from those of purely ceramic materials.

In a preferred development of the method, the variable design parameters describe a maximum first displacement of the tooth surface and/or a first length for defining a transition surface.

Here, the first displacement is preferably chosen such that for front and lateral teeth, no displacement occurs directly at the first boundary curve. In addition, for lateral teeth, no displacement is effected at the central fissure. The amount of the first displacement preferably increases continuously in the direction of the surface normal toward incisal or occlusal, starting from the first boundary curve, until the amount of displacement reaches the maximum first displacement.

The transition surface may be defined, for example, by setting the design parameter of the first length. Preferably, the first length thus defines a transition region, starting from the first boundary curve. The same is defined starting from zero up to the complete first displacement. A transition region is provided in order to realize an in particular smooth transition starting from the first boundary curve to the complete first displacement. By defining such a transition surface, it is possible to replicate the natural appearance of a tooth in which the enamel becomes ever thinner in the apical direction.

A transition surface may also be defined in such a manner that the first boundary curve is projected towards incisal or occlusal by the first length, whereby a second boundary curve is defined by this projection. In this case, the transition surface is defined between the first and the second boundary curve.

Thus, it is particularly preferred that the definition of the at least one interface inside the artificial tooth comprises at least the following steps:
defining a first boundary curve on the tooth surface,
determining a tooth surface that is incisal/occlusal with respect to the first boundary curve and
displacing this tooth surface inward in the direction of the surface normal by different amounts to create the at least one interface, in particular the first interface.

The variable design parameters preferably describe a maximum first displacement of the tooth surface and a first length for the definition of a transition surface, wherein upon a first displacement, no displacement is performed directly at the first boundary curve of front and lateral teeth and, in addition, at the central fissure of lateral teeth, and wherein, starting from the first boundary curve, the amount of the first displacement in the direction of the surface normal towards incisal or occlusal increases continuously until the maximum first displacement is reached, with the first length being set as a design parameter.

Further, the first boundary curve may be projected by the first length towards incisal/occlusal for the definition of a second boundary curve, wherein the transition surface is defined between the first and second boundary curves.

According to the disclosure, after the definition of an interface between the inner core element and at least one outer layer element surrounding the inner core element at least in part, at least one additional layer element is selected. According to the disclosure, an additional layer element is selected from a provided selection list including a plurality of additional layer elements. In particular, this may be a selection list or a selection box displayed on a monitor, so that a dentist or a dental technician can in a simple manner select individual or several additional layer elements included in the selection list, for example by simple clicking or marking. The dentist or dental technician thus does not have to model or otherwise create the additional layer elements, but merely has to select them. According to the method of the disclosure, the at least one selected additional layer element is automatically arranged in spatially defined relation to the core element and/or the outer layer element. Possibly, the automatic arrangement can be displayed directly on a monitor, so that the dentist or dental technician already gets a first impression as to whether by selecting one or a plurality of additional layer elements, the optical appearance of the artificial tooth to be inserted is close to the natural tooth.

The automatic arrangement of the at least one selected additional layer element is performed in spatially defined relation to the core element and/or the outer layer element. Preferably, the automatic arrangement is based on anatomic features and/or auxiliary lines or auxiliary points. The auxiliary lines and/or auxiliary points are preferably applied or defined based on anatomic features on the surfaces. In particular, the anatomic features and definitions of the auxiliary lines and/or the auxiliary points are different for each layer element. Preferably, this is performed as described hereinafter with respect to the respective layer elements.

The selection list may comprise in particular:

accentuation of mamelons and/or chromatic tooth neck and/or translucence effect and/or halo effect and/or horizontal band and/or surface effect.

The additional layer elements “translucence effect” and “halo effect” are in particular sub-sets of an additional layer element “incisal/occlusal optical effect”.

For the further improvement of the optical appearance of the additional tooth element, it is preferably possible to select a material and/or a color at least for individual additional layer elements. An additional layer element may also be made from different materials, have different colors or a color gradient. If ab additional layer element is provided in the additional tooth element not only once but several times, it is preferably possible to select different materials, colors and the like therefor, so that a corresponding material and/or color selection can be made separately for each additional layer element.

For the selection “accentuation of mamelons”, it is preferred that the same is arranged at the core element in the region of the mamelon. The at least one mamelon is preferably defined by the interface. It is possible to form a plurality of additional layer elements such that different additional layer elements “accentuation of mamelons” are arranged at different mamelons. It is preferred in particular that the additional layer element “accentuation of mamelons” is arranged at least partly in the outer layer element. In particular, for forming the additional layer element “accentuation of mamelons”, the interface is displaced at at least one mamelon. The displacement of the interface is effected in particular in the incisal direction.

It is preferred that the additional layer element “accentuation of mamelons” is arranged on the mamelon defined by the interface. In particular, the additional layer element “accentuation of mamelons” is set on the mamelon in a manner similar to a hood or hat.

In a preferred development of the method according to the disclosure, control points of at least one mamelon are defined. Preferably, the control points are height points. A height point defines the tip or the top portion of the mamelon. Preferably, control points, which are in particular height points, are displaced in the incisal direction. Low points, i.e. the lowest points between adjacent mamelons are preferably not displaced. A polygon defining the outer contour of the mamelons thus has maxima corresponding to the high points of the mamelons, and minima corresponding to the low points in the valleys between the mamelons. In a preferred embodiment, the maxima of the polygon are thus displaced in the incisal direction, while the minima are not displaced.

It is particularly preferred that the additional layer element “accentuation of mamelons” is formed in the region between the interfaces prior to and after the displacement of the interfaces. The displacement is preferably in a range from 0 to 1 mm and in particular in a range from 0 to 0.7 mm.

For defining such a polygon, first a third or a further boundary curve may be defined or created. This is done by projecting the first or second boundary curve by a second length, wherein the provision of a second boundary curve is optional. In particular, the third or further boundary curve is created by an incisal or occlusal projection of the first boundary curve or by an apical projection of the second boundary curve. As an alternative, the third boundary curve can be created manually or based on other features of the tooth element, e.g. the equator or the preparation boundary, independently of the first or second boundary curves.

Furthermore, preferably, an incisal or occlusal first surface contour is determined. The first surface contour is defined by the highest curve on the first interface created by the first maximal displacement. The highest curve can be determined automatically and be corrected manually, if necessary. Nodal points are created or defined on the first surface contour. Thereafter, the nodal points are displaced at least in part in the apical or incisal/occlusal direction. The nodal points, which are displaced at least in part, are interconnected forming a second surface contour. The second surface contour thus created defines the maximum second displacement of the tooth surface (or the first boundary surface) in the region of the incisal or occlusal surface contour. It is preferred to create two different mamelon curves which cause the second displacement according to the method steps described below. Here, two different mamelon curves create two different geometries. By “subtracting” the smaller geometry from the larger one, spaces are obtained in which the additional layer elements “accentuation of mamelons” are arranged.

In this preferred embodiment of the method according to the disclosure, the amount of the second displacement decreases continuously towards the surface normal by a third length in the apical direction in the case of front and lateral teeth, until at most the third boundary curve or a length defined as maximal for that purpose is reached. With lateral teeth, the amount of the second displacement also decreases continuously towards the central fissure until the central fissure is reached. Preferably, the amount of displacement immediately at the third boundary curve or immediately at the central fissure is “0”. The central fissure may also be defined manually and/or a manual correction of an automatically defined or predetermined central fissure may be made.

Preferably, the maximum first displacement of the tooth surface is in the range from 0 mm to 4 mm.

Furthermore, it is preferred that the first length, which is needed to create the transition surface, has an extension of 0.1 mm to 10 mm.

In a preferred development of the disclosure, the boundary, i.e. the beginning and the end of the automatically determined highest curve on the first and/or the second incisal surface contour, is defined by an angle in the case of front teeth. The angle is an angle between the tangents to the incisal surface contour and the tooth axis, wherein the angle is 0° to 90°, preferably 10° to 70° and particularly preferred 40° to 50°. For teeth, the teeth axis is defined as the connection line between the root tip of single-root teeth and the centre of the incisive edge or the chewing surface and, for multi-root teeth, between the root bifurcation and the centre of the chewing surface. In particular, it is also possible to manually define or adjust the boundaries, i.e. the beginning and the end, as well as the course of the incisal surface contour.

Preferably, the position of the nodal points on the incisal surface contour of front teeth is indicated or defined in relation to the total length of the incisal surface contour. Here, it is preferred that at least five points are defined on the incisal surface contour. It is preferred to define a higher number of points, in particular more than 10 and, as is particularly preferred, more than 20 points.

For lateral teeth, it is preferred that the position of the nodal points on the incisal/occlusal surface contour are indicated per cusp in relation to the lengths of the cusp ridges. In particular, the length of the cusp ridge between the mesial beginning of the cusp and the cusp tip or the cusp tip and the distal cusp end is used. Moreover, it is preferred that at least five points are defined per cusp on the total length of the occlusal surface contour. A higher number of at least 10, in particular at least 20 points is preferred.

The displacement of the nodal points on the incisal/occlusal surface contour in the apical direction is preferably in a range from −4.0 to +4.0 mm.

In addition to or instead of providing one or a plurality of additional layer elements “accentuation of mamelons” the additional layer element “chromatic tooth neck” may be selected. For the adaptation of the optical appearance of the artificial tooth element to the natural tooth it is often feasible and necessary to adapt, in particular to intensify, the tooth color in the region of the tooth neck. Here, it is particularly preferred to use material with a color shade that is more intense than the color shade of the dentin. In particular, this is a yellowish and/or brownish coloring of the tooth color.

When selecting the additional layer element “chromatic tooth neck”, this material is at least partly colored in a region of the outer layer element located apically with respect to a boundary curve.

To form the additional layer element “chromatic tooth neck”, the material of the outer layer element may be colored. In addition or as an alternative, an additional element of another material may be provided to design the additional layer element “chromatic tooth neck”. In this case, the same is preferably arranged within the outer layer element. Possibly, no outer layer element is provided in the region in which the additional layer element “chromatic tooth neck” is arranged, since the outer layer element does possibly not extend into the lower region of the tooth neck. In this respect, the additional layer element “chromatic tooth neck” may also be provided in its entirety or in part in the core element, the core element possibly forming the outer layer of the artificial tooth element in the region of the tooth neck.

The additional layer element “chromatic tooth neck” is preferably limited by the outer contour of the outer layer element. For an improvement of the optical appearance, it is also possible to arrange the additional layer element “chromatic tooth neck” partly under the outer layer element, in particular if the outer layer element extends completely to the lower side of the tooth and thus at least a part of the tooth neck is covered by the outer layer element.

Furthermore, it is possible in particular for designing a continuous color gradient to change the layer thickness of the additional layer element “chromatic tooth neck”, so the same decreases in particular in the apical and/or incisal or occlusal direction.

In addition or instead of the above described additional layer elements “accentuation of mamelons” and/or “chromatic tooth neck”, it is preferred to provide an additional layer element “incisal/occlusal optical effect”. The additional layer element “incisal/occlusal optical effect” is in particular the additional layer element “translucence effect” or “halo effect”.

A translucence effect or a transparency effect often occurs in the incisal region of a crown or a tooth. The additional layer element “translucence effect” is preferably arranged in an incisal edge region of the artificial tooth element within the outer layer element. Here, it is preferred that the additional layer element “translucence effect” is limited by the outer contour of the outer layer element, wherein in particular the additional layer element “translucence effect” is arranged at the outer edge of the artificial tooth, so that the additional layer element “translucence effect” forms the outer contour of the tooth.

For a definition of the additional layer element “translucence effect”, it is preferred to perform an in particular automatic arrangement of control points on the surface of the outer layer element. These are then displaced apically.

The additional layer element “translucence effect” is preferably arranged as described for the additional layer element “accentuation of mamelons” with respect to the definition of the polygon. However, it is preferred in this case to reduce the outer contour to a lesser degree.

The displacement is preferably performed along a normal to the surface of the outer layer element. It is particularly preferred that a displacement by 0 to 1 mm, in particular 0 to 0.5 mm, is performed.

Furthermore, it is preferred that the additional layer element “translucence effect” is formed in the region between the surface of the outer layer element prior to and after the displacement. Here, it is particularly preferred that the outer contour of the additional layer element “translucence effect” is limited by the original outer contour of the outer layer element.

A further optical effect is the halo effect. As such, the dentist or dental technician may select the additional layer element “halo effect” in addition to or instead of the above described additional layer elements. The halo effect is a slight bright accentuation of the incisal edge of the artificial tooth element. The same is usually less marked that the translucence. Preferably, the additional layer element “halo effect” is arranged and dimensioned etc. in analogy to the additional layer element “translucence effect”. The markedness of the additional layer element “halo effect” is preferably less than the markedness of the additional layer element “translucence effect”.

A further additional or alternative additional layer element is the additional layer element “horizontal band”.

For an in particular automatic arrangement of the additional layer element “horizontal band”, it is preferred that first a horizontal line is defined on the tooth element. With reference to the height of the tooth element it is preferred to arrange the horizontal line approximately in the central region of the tooth element. In particular, the horizontal line is defined with respect to the height of the tooth element ±10%. Starting from the horizontal line, the horizontal band extends for a predetermined width in both directions. The width is preferably in the range from 0.3 mm to 2 mm. Besides this incisal/apical dimension, the horizontal band preferably has a depth of 0.2 to 1.5 mm. It is further preferred that the horizontal band is arranged between the core element and the outer layer element and in particular extends into the core element and/or the outer layer element.

As with the other additional layer elements, it is possible also for the additional layer element “horizontal band” to select a material, possibly a plurality of different materials, as well as a coloring, which may again be a color gradient or different colors.

A further additional layer element is the additional layer element “surface effect”. The additional layer element “surface effect” is arranged on the interface (i.e. the surface between the core element and the outer layer element) in a front portion. The front region is the frontward, visible portion of the tooth when the tooth element is in place. The additional layer element “surface effect” is relevant in particular for incisors. For the arrangement of the additional layer element “surface effect”, an in particular virtual grid can be arranged on the interface. The same has crossing or intersection points. By selecting corresponding intersection points, it is possible to define the area in which the additional layer element “surface effect” is arranged. The additional layer element “surface effect” has a width of preferably 1 to 8 mm, a height of preferably 1 to 10 mm and a depth of preferably 0.1 to 1 mm. Further, the additional layer element “surface effect” extends into the core element and/or into the outer layer element.

If so desired, the additional layer element “accentuation of mamelons” can be covered by the additional layer element “surface effect” or the additional layer element “horizontal band”.

It is particularly preferred for the execution of the method according to the disclosure to provide a virtual grid that is placed on the surface of the outer layer element. Thereby, it is possible to automatically define control points which are in particular intersection points of the grid lines. These control points may then be used to define the position and extension of individual additional layer elements. Thereby, in particular a good and automatic positioning of the individual additional layer elements is possible.

Preferably, the vertical and the horizontal extension of the virtual grid is defined by the maximum vertical and horizontal dimension of the outer contour silhouette of the tooth element. It is further preferred that the grid has vertical and horizontal lines that preferably divide the tooth contour equidistantly. Here, the outer contour silhouette is the projected contour of the tooth element in front view.

All additional layer elements can be arranged individually or in combination with each other. Besides the preferred selection of materials, colors, color gradients and the like, a dentist or a dental technician can also define the position and the markedness, i.e. the dimensions of the individual additional layer elements. Preferably, the system automatically suggests a position and a markedness for the corresponding additional layer elements as a function of the type and the patient-specific size of the tooth element. Corresponding measures can be defined in particular automatically, for example, by the defined size or the outer dimensions of the additional layer element. It is also possible that a system automatically suggests designs, materials etc. This may be done, for example, by an automatic comparison with the natural tooth to be replaced or other, in particular adjacent natural teeth of the patient, based on photos or images.

In the following, the disclosure is described in more detail by means of preferred embodiments with reference to the accompanying drawings.

### BRIEF DESCRIPTION OF THE DRAWINGS

In the Figures:

FIG. 1 is a schematic front view of an artificial tooth element of a front tooth,

FIG. 2 is a schematic side view of an artificial tooth element of a front tooth,

FIGS. 3 and 4 are a schematic front view and a lateral view of an artificial tooth element of a front tooth of FIGS. 1 and 2, showing additional surfaces and curves,

FIGS. 5 and 6 are a schematic front view and a lateral view of an artificial tooth element of a front tooth of FIGS. 1 and 2, showing additional surfaces and curves,

FIG. 7 is an incisal view of the tooth element illustrated in FIG. 5,

FIGS. 8a to 8c are alternative illustrations of FIG. 5 with different tangent angles,

FIG. 9 is a schematic illustration of a first and a second surface contour,

FIG. 10 is a schematic front view of a tooth element of a front tooth of FIGS. 1 and 2, showing additional surfaces and curves,

FIG. 11 is a schematic side view along sectional plane XI in FIG. 10,

FIG. 12 is a schematic side view of an artificial tooth element of a lateral tooth,

FIG. 13 is a schematic view of the artificial tooth element of a lateral tooth illustrated in FIG. 12, seen from the incisal direction,

FIG. 14 is a schematic front view of a detail of an artificial tooth element for determining the arrangement of the additional layer element “accentuation of mamelons”,

FIG. 15 is a side view of the artificial tooth element illustrated in FIG. 14,

FIG. 16 is a front view and a side view of an artificial tooth element together with the additional layer element “accentuation of mamelons”,

FIG. 17 is a front view and a side view of an artificial tooth element together with the additional layer element “chromatic tooth neck”,

FIG. 18 is a detail of an artificial tooth element for the clarification of the additional layer element “chromatic tooth neck”,

FIG. 19 is a front view and a side view of an artificial tooth element for the clarification of the additional layer element “translucence effect”,

FIG. 20 is a front view and a side view of an artificial tooth element for the clarification of the additional layer element “horizontal band”,

FIG. 21 is a front view and side views of an artificial tooth element for the clarification of the additional layer element “surface effect”,

FIG. 22 is a front view and a side view of an artificial tooth element with a virtual grid,

FIG. 23 is a front view and a side view of an artificial tooth element with a virtual grid in combination with the manufacturing of the additional layer element “translucence effect” and

FIG. 24 is a front view and a side view of an artificial tooth element with a virtual grid in combination with the manufacturing of the additional layer element “surface effect”.

### DETAILED DESCRIPTION OF THE PREFERRED EMBODIMENT

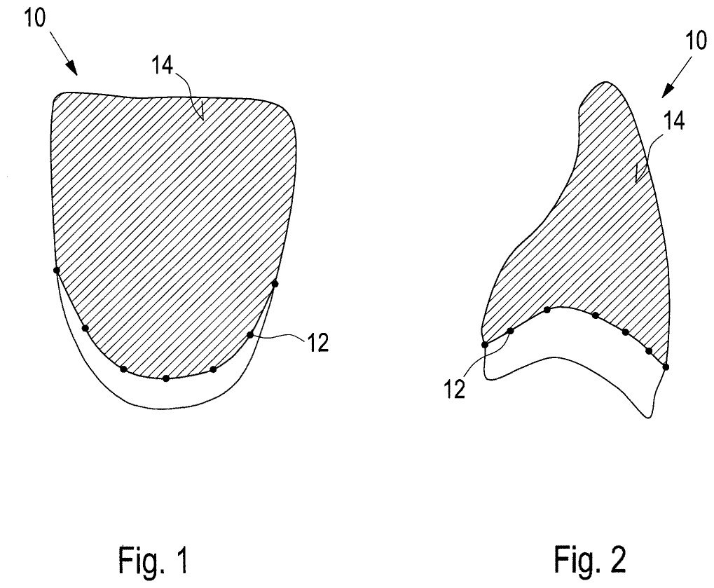

For the execution of the method of the disclosure, it is first necessary to define an interface between an inner core element and an outer layer element surrounding this core element at least partly. A possible method for defining this interface will be explained in detail hereunder with reference to FIGS. 1 to 13.

FIGS. 1 and 2 illustrate an artificial tooth element 10 of a front tooth in front and side view. This is the three-dimensional outer contour of the tooth element, wherein, preferably, a corresponding data set is opened that includes the data of the three-dimensional outer contour of the tooth element. After the alignment of the tooth element 10 with a coordinate system (not illustrated), a first boundary curve 12 is defined, wherein the first boundary curve 12 can be defined manually and/or based on a preparation boundary or based on a tooth equator. The first boundary curve 12 defines a tooth surface 14 in the incisal direction, i.e. above the first boundary curve 12 in FIGS. 1 and 2.

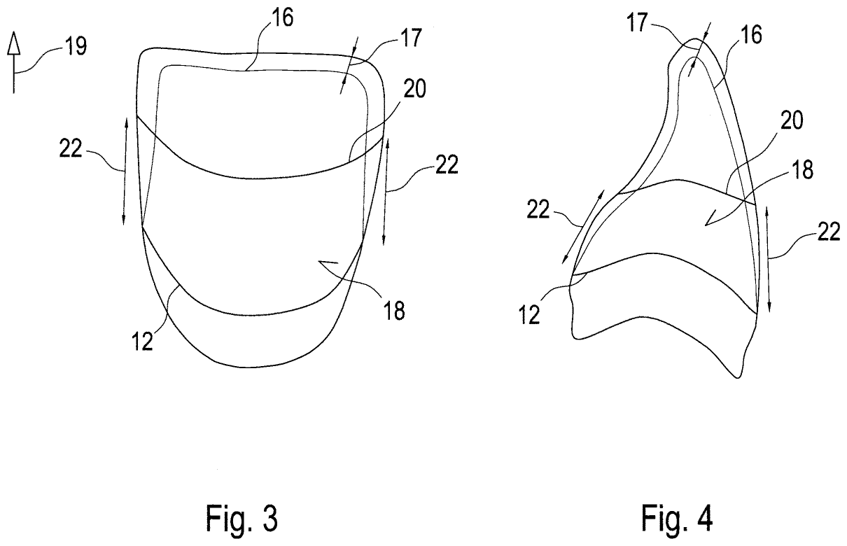

The tooth surface 14 is displaced inward towards the surface normal in order to create a first interface 16 (FIGS. 3 and 4). Here, a maximum displacement 17 is illustrated as an example.

As illustrated in FIGS. 3 and 4, according to a preferred embodiment of the disclosure, a transition surface 18 extending in the incisal direction 19 can be defined starting from the first boundary curve 12. In the embodiment illustrated, the transition surface 18 is defined in such a manner that a second boundary curve 20 is defined. The second boundary curve 20 can be obtained by projecting the first boundary curve 12 by a first length 22.

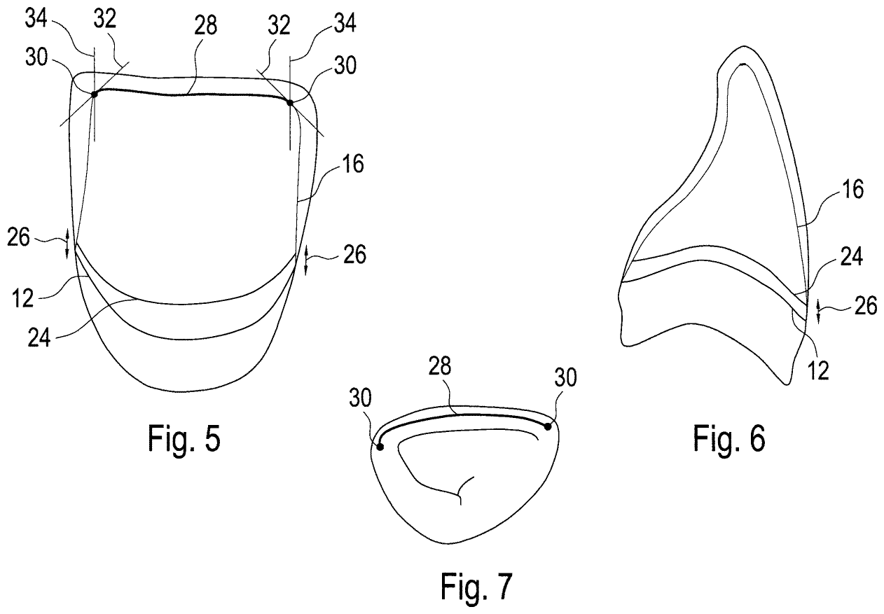

In the embodiment illustrated, further, a third boundary curve 24 is defined (FIGS. 5 and 6). The third boundary curve 24 can be obtained by projecting the first boundary curve 12 by a second length 26.

The highest curve on the first interface 16 created by the first maximum displacement is defined as an incisal/occlusal first surface contour 28. The first surface contour 28 has two boundaries 30 and in particular a beginning and an end. Here, the boundaries 30 are defined by tangents 32. In FIG. 5, the angle of the tangents 32 with respect to the tooth axis 34 is about 45°.

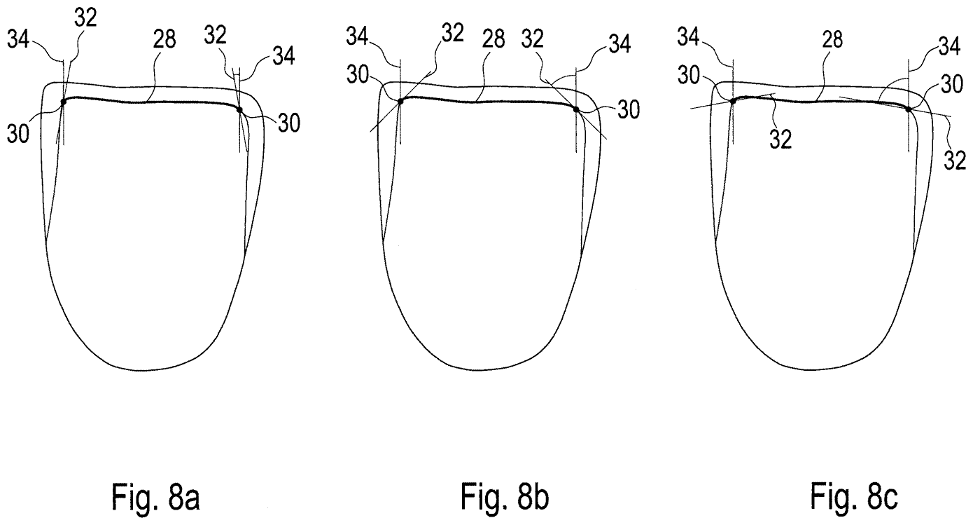

As illustrated in FIGS. 8a to 8c, the position of the boundaries 30 changes as the tangent angle is changed.

The course of the first surface contour 28 is illustrated in top plan view or seen from incisal (FIG. 7).

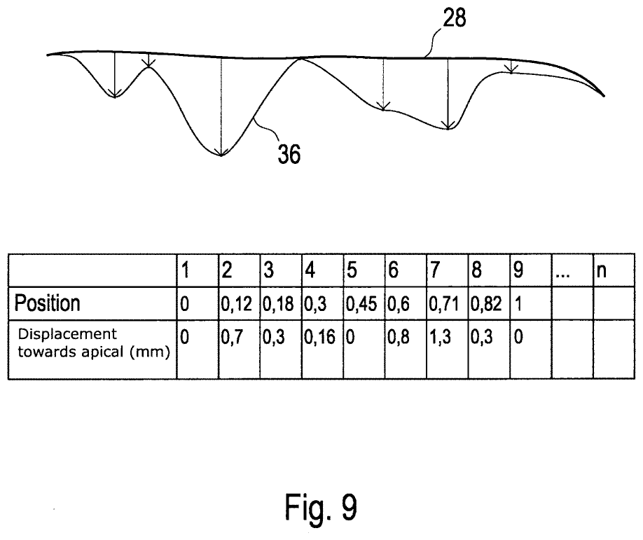

A number of nodal points (FIG. 9) is defined on the surface contour. In FIG. 9, these nodal points are designated as an example as nodal point 1 to nodal point 9 and are listed in a table. As illustrated by arrows, the nodal points located on the first surface contour 28 is displaced in the apical direction. Connecting the displaced nodal points yields the second surface contour 36.

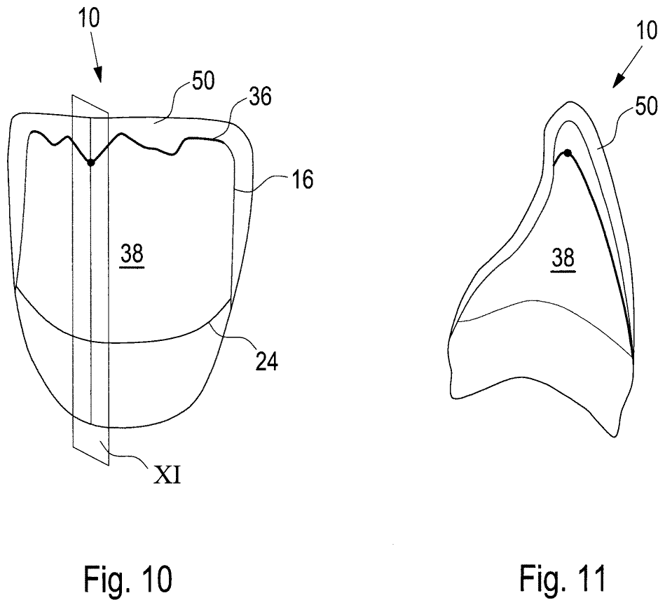

In the embodiment illustrated, the above method steps result in a three-dimensional interface defined by the third boundary curve 24, parts of the first interface 16 and the second surface contour 36 (FIGS. 10 and 11). In a preferred embodiment according to the disclosure, another material is provided inside this three-dimensional surface, i.e. in the space 38, than in the volume of the artificial tooth element 10 surrounding this space. These two volumes are defined in particular by different materials, with the inner volume 38 imitates the dentin. Here, the interface between the volume forming the dentin and the surrounding volume is not identical with the corresponding interface of the associated natural tooth.

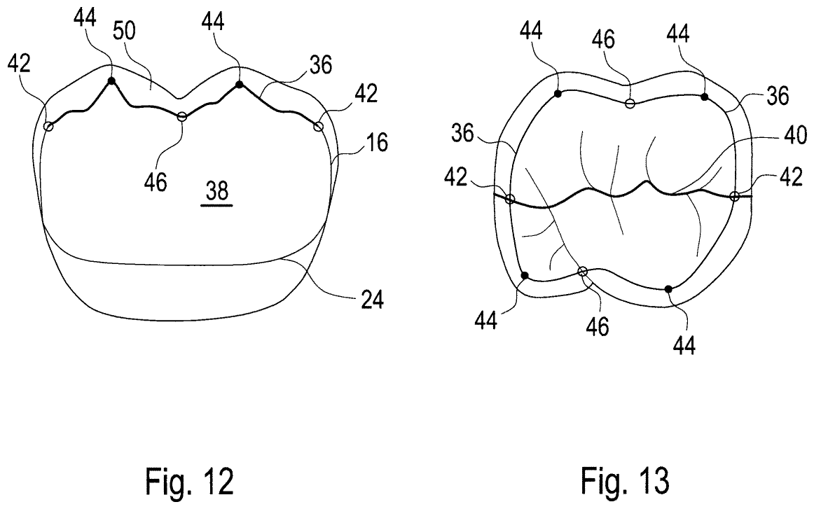

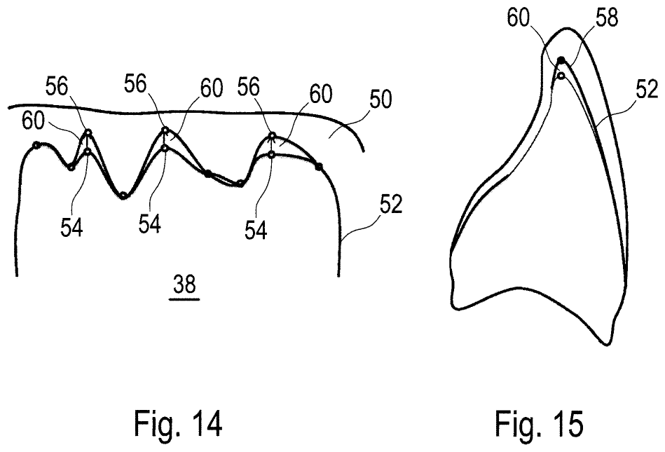

FIGS. 12 and 13 illustrate the corresponding contours for a lateral tooth, wherein these correspond to the contours described for the protruding edge of a front tooth. In addition, the central fissure 40 (FIG. 13) is illustrated. The line illustrating the central fissure 40 has two boundary points 42 that represent the beginning of a cusp and the end of a cusp, respectively. Furthermore, cusp tips 44 are marked on the second surface contour 36. A point 46 defines a cusp end and the beginning of a next cusp.

In a three-dimensional interface defined according to the above method steps, the inner volume 38 forms the inner core element and the volume 50 surrounding the inner volume 38 forms the outer layer element.

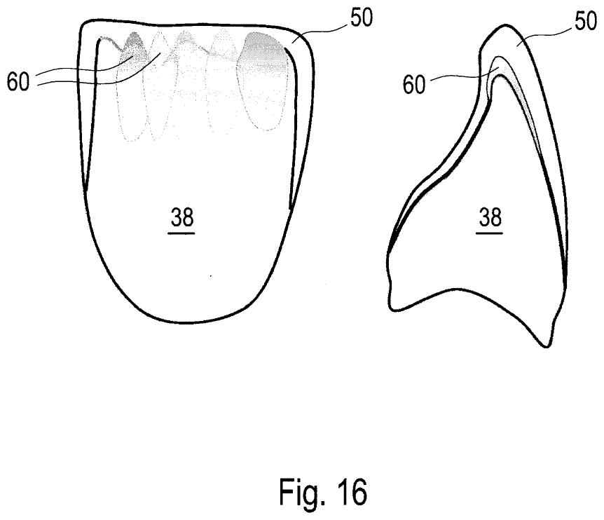

For the arrangement of the additional layer element “accentuation of mamelons”, high points 54 are defined in a preferred embodiment on the silhouette curve 52, i.e. the boundary curve between the inner core element 38 and the outer layer element 50. The high points 54 are displaced towards incisal, so that points 56 are defined. The position of the silhouette curve 52 is changed accordingly. Interstices 60 are formed between the silhouette curve 52 and the interface 58 defined by the points 56 after the incisal displacement. In these interstices 60, the additional layer elements “accentuation of mamelons” are arranged. These may be colored differently or be made from different materials, as indicated in particular in FIG. 16.

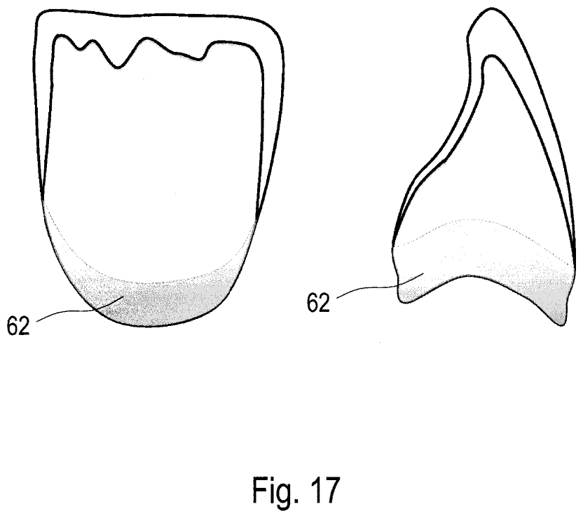

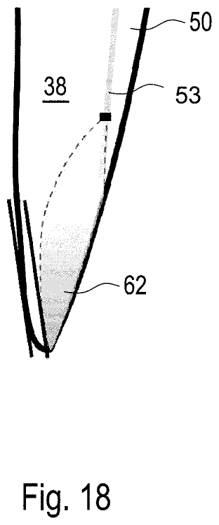

FIGS. 17 and 18 illustrate an example of the additional layer element “chromatic tooth neck”. As can be seen, the artificial tooth element is colored in the region of the tooth neck, so that an additional element is arranged. The additional layer element “chromatic tooth neck” 62 can be arranged at least in part within the core element 38, as can be seen in FIG. 18. This is defined in particular by where the interface 53 is arranged. The additional layer element “chromatic tooth neck” is preferably limited by the outer contour of the outer layer element 50. Likewise, it is possible that for a change of the optical appearance, the additional layer element “chromatic tooth neck” 62 is arranged in part within the outer layer, so that the outer layer element 50 covers the additional layer element “chromatic tooth neck” 62 with a layer that may be thin.

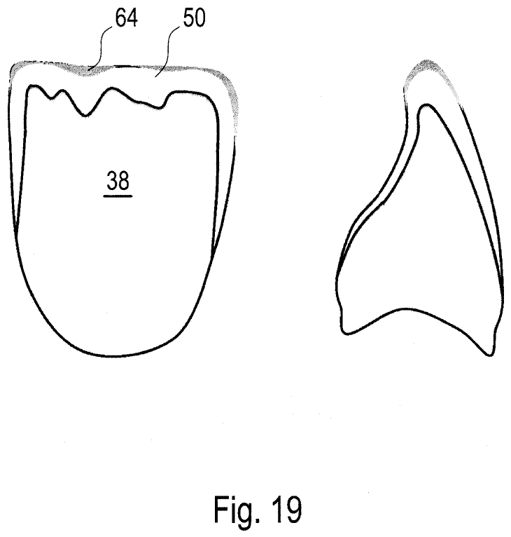

A further additional layer element shown schematically in FIG. 19 is the additional layer element “translucence effect” 64. This is an additional layer element that is provided in the incisal edge region of the artificial tooth element within the outer layer element 50. For the definition of the position and the design of the additional layer element “translucence effect” 64, control points can be defined on an upper surface of the outer layer element, which are then displaced inward, i.e. towards the inner core element.

In a preferred embodiment, the outer boundary of the additional layer element “translucence effect” represents the outer surface of the outer layer element 50.

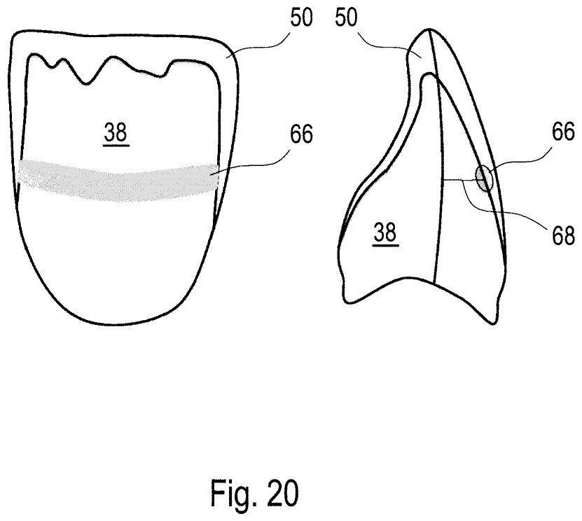

Another additional layer element “horizontal band” 66, shown in particular in FIG. 20, is a horizontal line arranged approximately in the central region of the artificial tooth element. The horizontal band preferably starts from a horizontal line 68 arranged approximately at the level of the center of the tooth element. The horizontal band 66 may be elliptic in cross section. In particular, the horizontal band 66 protrudes partly into the outer layer element 50 and is arranged in part within the inner partial element 38.

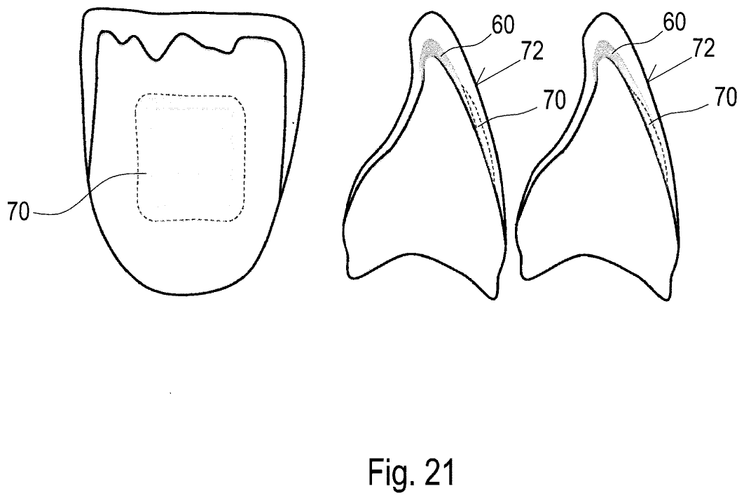

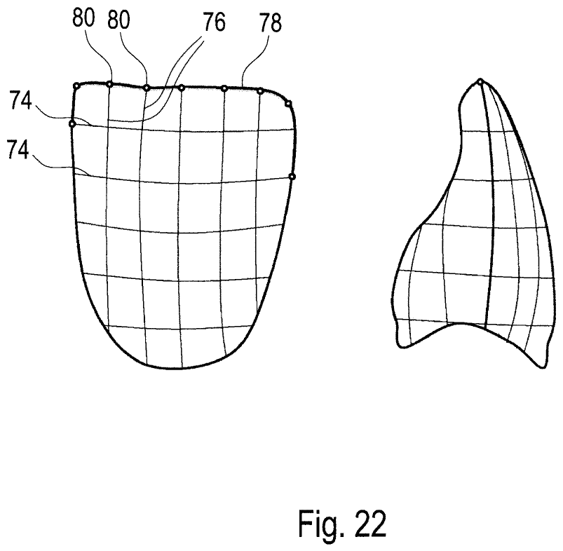

A further additional layer element (FIG. 21) is the additional layer element “surface effect” 70. The same is arranged in a front region of the artificial tooth element, preferably between the core element 38 and the outer layer element 50. If an overlap in the vertical direction exists between the additional layer element “surface effect” 70 and the additional layer element “accentuation of mamelons” 60, the additional layer element “surface effect” can be arranged in front of or behind the additional layer element “accentuation of mamelons” 60 with respect to a front side 72 of an incisor illustrated in FIG. 1.

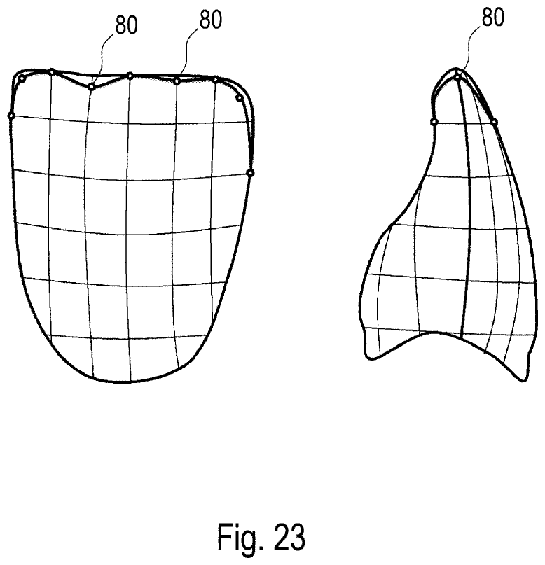

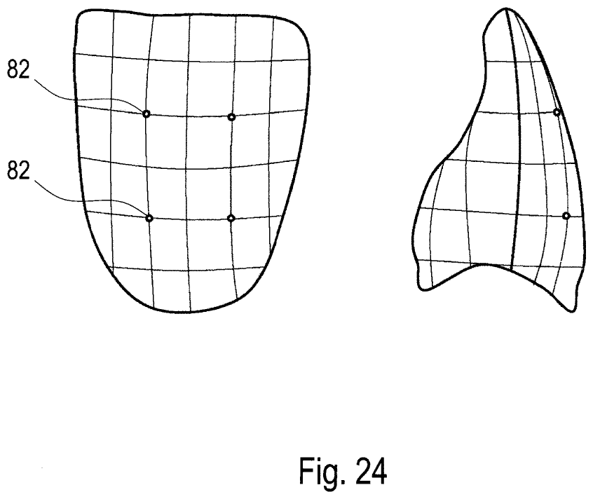

For the execution and in particular the at least partial automation of the method according to the disclosure, a virtual grid (FIGS. 23 to 24) is preferably provided. The virtual grid comprises in particular equidistantly arranged horizontal lines 74 and vertical lines 76. As the outer boundary, the grid has the outer contour silhouette 78 of the artificial tooth element. Nodal points 80 can be defined by points of contact of the vertical and horizontal lines 74, 76 with the outer contour silhouette. Further nodal points 82, see for example FIG. 24, can be defined at the crossing points of the horizontal and vertical lines 74, 76.

Using the individual nodal points 80, 82, the alignment, the size etc. of the individual additional layer elements can be defined and adjusted in a simple manner, in particular also automatically.

For example, the nodal points 80 arranged on the silhouette 78 may be used for the translucence effect by displacing individual points, as can be seen in FIG. 23.

As can be seen from FIG. 24, for example, nodal points 82 can be used to define the position of the surface effect. Other nodal points may be used to define the remaining additional layer elements.

What is claimed is:

1. Method for defining different layer elements of an artificial tooth element comprising the steps of:
defining an interface between an inner core element and at least one outer layer element which surrounds the inner core element at least in part,
selecting an additional layer element from a provided selection list containing a plurality of additional layer elements, which includes:
accentuation of mamelons and/or chromatic tooth neck and/or translucence effect and/or halo effect and/or horizontal band and/or surface effect, and
automatically arranging the at least one selected additional layer element in spatially defined relation to the core element and/or the outer layer element.

2. Method according to claim 1, in which a material and/or a color can be selected at least for individual additional layer elements.

3. Method according to claim 1, in which, when selecting the additional layer element “accentuation of mamelons”, an additional layer element “accentuation of mamelons” is arranged at the core element in the region of at least one mamelon defined by the interface, the additional layer element covering the at least one mamelon at least in part.

4. Method according to claim 3, in which the additional layer element “accentuation of mamelons” is arranged at least partly within the outer layer element.

5. Method according to claim 3, in which, for forming the additional layer element “accentuation of mamelons”, the interface at at least one mamelon is displaced in particular incisally, wherein control points of at least one mamelon, which are defined in particular by height points, are displaced incisally,
wherein the additional layer element “accentuation of mamelons” is formed in the region between the interface prior to and after the displacement and/or the displacement is 0 to 1.0 mm.

6. Method according to claim 1, in which, when selecting the additional layer element “chromatic tooth neck”, a material is at least partly colored in a region of the outer layer element located apically with respect to a boundary curve.

7. Method according to claim 1, in which, when selecting the additional layer element “chromatic tooth neck”, the outer layer element, is replaced at least partly with the additional layer element “chromatic tooth neck” in a region located apically with respect to a boundary curve and/or in which the outer contour of the additional layer element “chromatic tooth neck” is limited by the outer contour of the outer layer element.

8. Method according to claim 1, in which, when selecting the additional layer element “incisal/occlusal optical effect”, which includes in particular the additional layer element “translucence effect” and/or the additional layer element “halo effect”, the additional layer element “incisal/occlusal optical effect” is arranged within the outer layer element in an incisal edge region of the artificial tooth element.

9. Method according to claim 8, in which the additional layer element “incisal/occlusal optical effect” is limited by the outer contour of the outer layer element and/or in which, for the definition of the additional layer element “incisal/occlusal optical effect”, control points defined on the surface of the outer layer element are displaced apically, wherein the displacement occurs along a normal to the surface of the outer layer element.

10. Method according to claim 8, in which a displacement by 0 to 1 mm occurs and/or in which the additional layer element “incisal/occlusal optical effect” is formed in the region between the surface prior to and after the displacement and/or in which the outer contour of the additional layer element “incisal/occlusal optical effect” is limited by the outer contour of the outer layer element.

11. Method according to claim 1, in which, when selecting the additional layer element “horizontal band”, a horizontal center line is defined and the additional layer element “horizontal band” is arranged between the core element and the outer layer element in the region of the center line, wherein the additional layer element “horizontal band” protrudes into the core element and/or the outer layer element,
wherein the additional layer element “horizontal band” comprises an incisal/apical dimension from 0.3 to 2 mm and/or a depth from 0.2 to 1.5 mm.

12. Method according to claim 1, in which, when selecting the additional layer element “surface effect”, the additional layer element “surface effect” is arranged on the interface in a front region. wherein the additional layer element “surface effect” partly overlaps with the additional layer element “accentuation of mamelons”,
wherein the additional layer element “surface effect” has a width of 1 to 8 mm, a height of 1 to 10 mm, and a depth of 0.1 to 1 mm.

13. Method of claim 12, in which the additional layer element “surface effect” is arranged in the core element and/or in the outer layer element and is limited by the outer contour of the outer layer element.

14. Method according to claim 1, in which, for an automatic definition of control points, a virtual grid is applied on the surface of the outer layer element, wherein the vertical and the horizontal dimension of the grid is defined by the maximum dimension of the outer contour silhouette, wherein the grid comprises a plurality of vertical and/or horizontal lines that divide the tooth contour equidistantly.

15. Method according to claim 14, in which the intersection points of the horizontal and vertical lines define the control points and/or in which control points are defined at intersection points of the vertical and/or horizontal lines and an outer contour silhouette.
